(19) United States
(12) Patent Application Publication
(10) Pub. No.: US 2022/0391676 A1
(43) Pub. Date: Dec. 8, 2022

(54) QUANTIZATION EVALUATOR

(71) Applicant: Black Sesame International Holding Limited, San Jose, CA (US)

(72) Inventors: Zihao Zhao, San Jose, CA (US); Chenghao Zhang, Sunnyvale, CA (US); Yi Wang, San Jose, CA (US); Zexi Ye, Santa Clara, CA (US); Hui Wang, Sunnyvale, CA (US); Zheng Qi, Cupertino, CA (US); Qiang Zhang, Campbell, CA (US)

(73) Assignee: Black Sesame International Holding Limited

(21) Appl. No.: 17/339,616

(22) Filed: Jun. 4, 2021

(51) Int. Cl. G06N 3/063; G06F 7/483

(52) U.S. Cl. CPC G06N 3/063; G06F 7/483

(57) ABSTRACT

A method of quantization evaluation, including, receiving a floating point data set, determining a floating point neural network model output utilizing the floating point data set, quantizing the floating point data set utilizing a quantization model yielding a quantized data set, determining a quantized neural network model output utilizing the quantized data set, determining whether an accuracy error between the floating point neural network model output and the quantized neural network model output exceeds an predetermined error tolerance, determining a floating point neural network tensor output utilizing the floating point data set if the predetermined error tolerance is exceeded, determining a quantized neural network tensor output utilizing the quantized data set if the predetermined error tolerance is exceeded, determining a per-tensor error based on the floating point neural network tensor output and the quantized neural network tensor output and updating the quantization model based on the per-tensor error.

### BACKGROUND

### Technical Field

The instant disclosure is related to neural network acceleration and more specifically to quantization evaluation for a neural network.

### Background

Currently, neural networks utilize floating point inputs and the use of quantized inputs has no orderly analysis and revision of quantization to match floating point results.

### SUMMARY

A method of quantization evaluation, comprising, receiving a floating point data set, determining a floating point neural network model output utilizing the floating point data set, quantizing the floating point data set utilizing a quantization model yielding a quantized data set, determining a quantized neural network model output utilizing the quantized data set, determining whether an accuracy error between the floating point neural network model output and the quantized neural network model output exceeds an predetermined error tolerance, determining a floating point neural network tensor output utilizing the floating point data set if the predetermined error tolerance is exceeded, determining a quantized neural network tensor output utilizing the quantized data set if the predetermined error tolerance is exceeded, determining a per-tensor error based on the floating point neural network tensor output and the quantized neural network tensor output and updating the quantization model based on the per-tensor error.

A method of quantization evaluation, comprising, receiving a floating point data set, determining a floating point neural network model output utilizing the floating point data set, quantizing the floating point data set utilizing a quantization model yielding a quantized data set, determining a top-l quantized neural network model output utilizing the quantized data set, determining a top-k quantized neural network model output utilizing the quantized data set, determining whether a top-l accuracy error between the floating point neural network model output and the top-l quantized neural network model output exceeds a predetermined error tolerance, determining whether a top-k accuracy error between the floating point neural network model output and the top-k quantized neural network model output exceeds the predetermined error tolerance, determining a floating point neural network tensor output utilizing the floating point data set if the predetermined error tolerance is exceeded, determining a top-l quantized neural network tensor output utilizing the quantized data set if the predetermined error tolerance is exceeded, determining a top-k quantized neural network tensor output utilizing the quantized data set if the predetermined error tolerance is exceeded, determining a top-l per-tensor error based on the floating point neural network tensor output and the top-l quantized neural network tensor output of an intermediate tensor, determining a top-k per-tensor error based on the floating point neural network tensor output and the top-k quantized neural network tensor output of the intermediate tensor and updating the quantization model based on the top-l per-tensor error and the top-k per-tensor error.

### DESCRIPTION OF THE DRAWINGS

In the drawings:

FIG. 1 is a first example system diagram in accordance with one embodiment of the disclosure;

FIG. 2 is a second example system diagram in accordance with one embodiment of the disclosure;

FIG. 3 is an example quantization evaluation workflow in accordance with one embodiment of the disclosure;

FIG. 4 is a first example method of quantization evaluation in accordance with one embodiment of the disclosure;

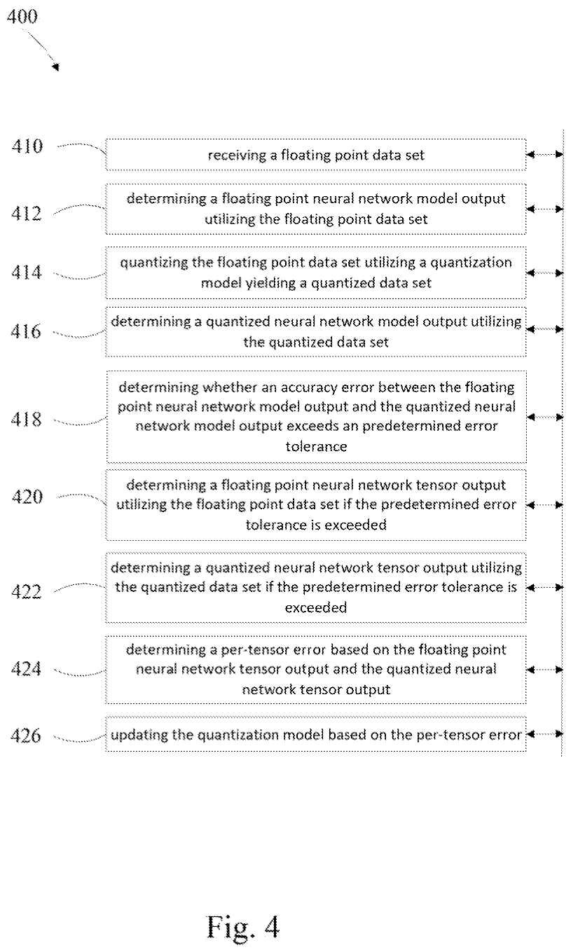

FIG. 5 is a second example method of quantization evaluation in accordance with one embodiment of the disclosure;

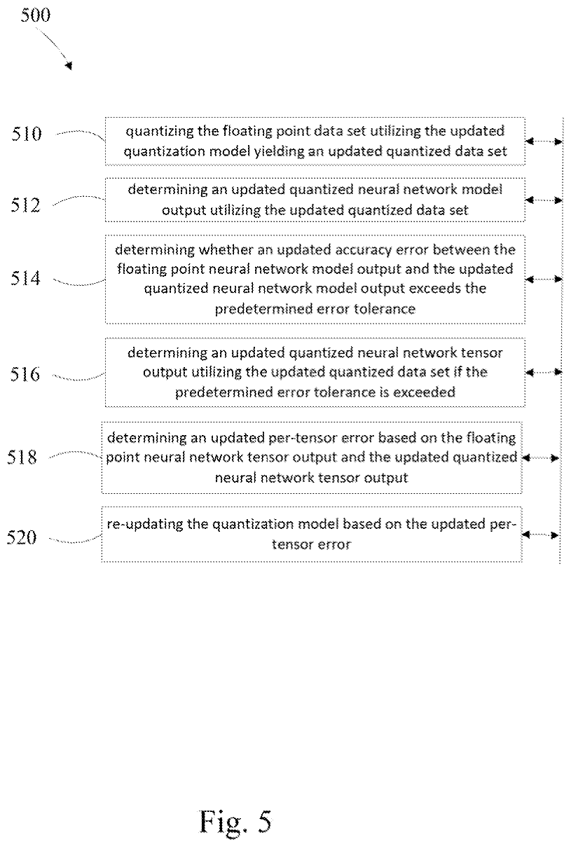

FIG. 6 is a third example method of quantization evaluation in accordance with one embodiment of the disclosure; and

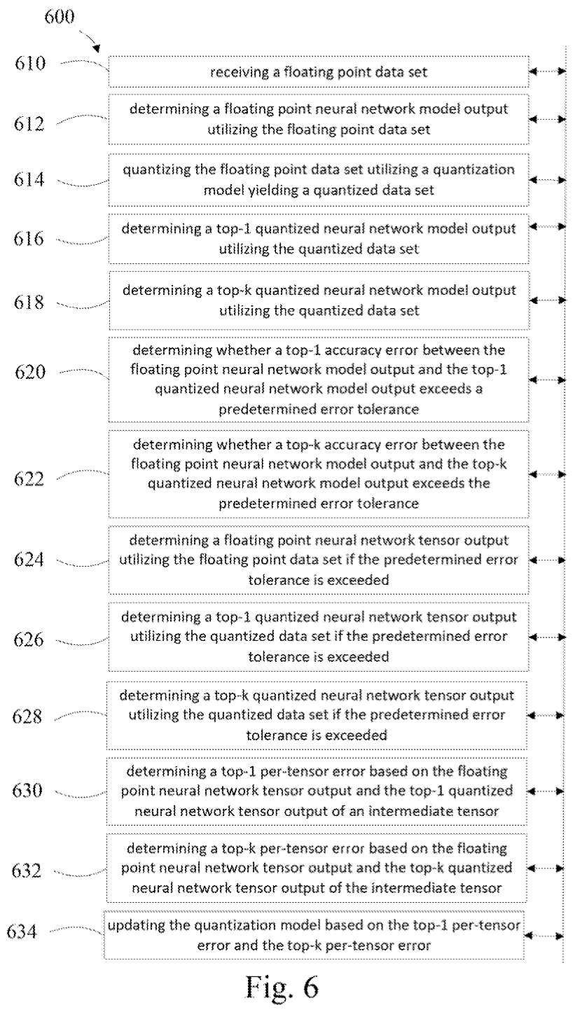

FIG. 7 is a fourth example method of quantization evaluation in accordance with one embodiment of the disclosure.

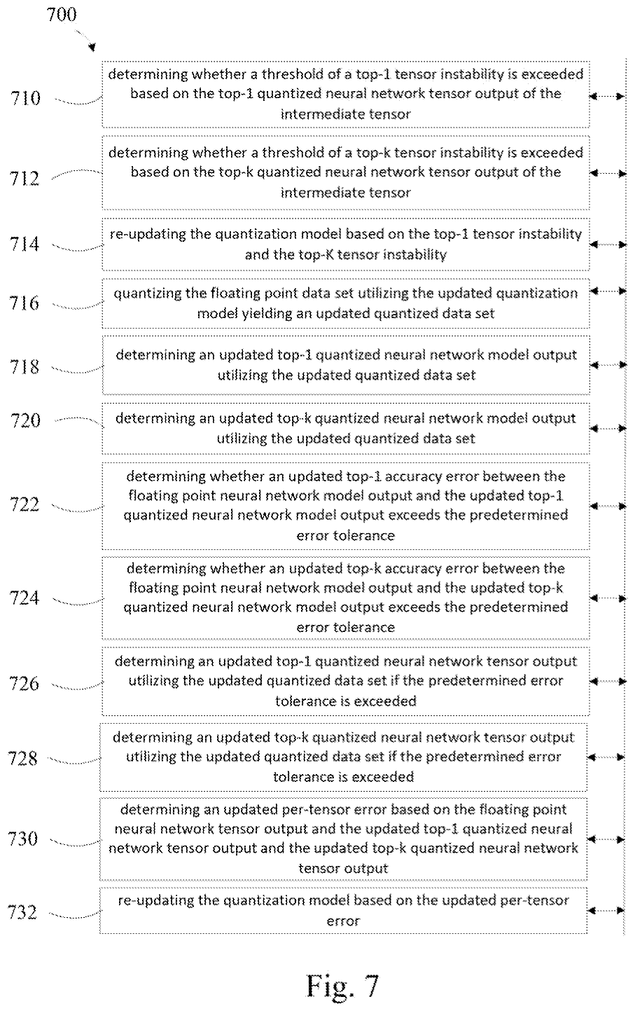

### DETAILED DESCRIPTION OF THE INVENTION

The embodiments listed below are written only to illustrate the applications of this apparatus and method, not to limit the scope. The equivalent form of modifications towards this apparatus and method shall be categorized as within the scope the claims.

Certain terms are used throughout the following description and claims to refer to particular system components. As one skilled in the art will appreciate, different companies may refer to a component and/or method by different names. This document does not intend to distinguish between components and/or methods that differ in name but not in function.

In the following discussion and in the claims, the terms “including” and “comprising” are used in an open-ended fashion, and thus may be interpreted to mean “including, but not limited to . . . .” Also, the term “couple” or “couples” is intended to mean either an indirect or direct connection. Thus, if a first device couples to a second device that connection may be through a direct connection or through an indirect connection via other devices and connections.

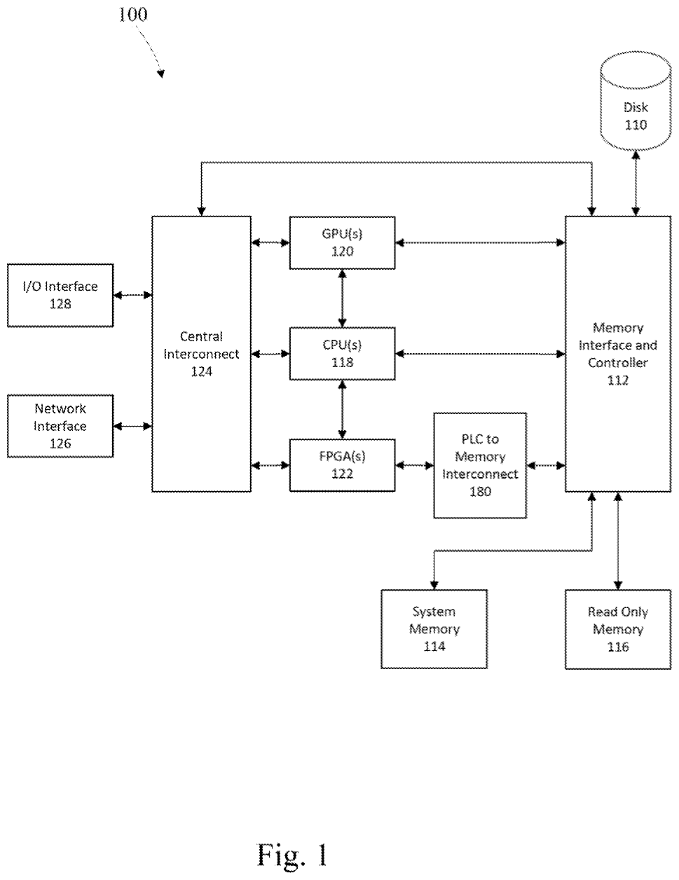

FIG. 1 depicts an example hybrid computational system 100 that may be used to implement neural nets associated with the operation of one or more portions or steps of the processes. In this example, the processors associated with the hybrid system comprise a field programmable gate array (FPGA) 122, a graphical processor unit (GPU) 120 and a central processing unit (CPU) 118.

The CPU 118, GPU 120 and FPGA 122 have the capability of providing a neural net. A CPU is a general processor that may perform many different functions, its generality leads to the ability to perform multiple different tasks, however, its processing of multiple streams of data is limited and its function with respect to neural networks is limited. A GPU is a graphical processor which has many small processing cores capable of processing parallel tasks in sequence. An FPGA is a field programmable device, it has the ability to be reconfigured and perform in hardwired circuit fashion any function that may be programmed into a CPU or GPU. Since the programming of an FPGA is in circuit form, its speed is many times faster than a CPU and appreciably faster than a GPU.

There are other types of processors that the system may encompass such as an accelerated processing unit (APUs) which comprise a CPU with GPU elements on chip and digital signal processors (DSPs) which are designed for performing high speed numerical data processing. Application specific integrated circuits (ASICs) may also perform the hardwired functions of an FPGA; however, the lead time to design and produce an ASIC is on the order of quarters of a year, not the quick turn-around implementation that is available in programming an FPGA.

The graphical processor unit 120, central processing unit 118 and field programmable gate arrays 122 are connected and are connected to a memory interface controller 112. The FPGA is connected to the memory interface through a programmable logic circuit to memory interconnect 130. This additional device is utilized due to the fact that the FPGA is operating with a very large bandwidth and to minimize the circuitry utilized from the FPGA to perform memory tasks. The memory and interface controller 112 is additionally connected to persistent memory disk 110, system memory 114 and read only memory (ROM) 116.

The system of FIG. 1A may be utilized for programming and training the FPGA. The GPU functions well with unstructured data and may be utilized for training, once the data has been trained a deterministic inference model may be found and the CPU may program the FPGA with the model data determined by the GPU.

The memory interface and controller is connected to a central interconnect 124, the central interconnect is additionally connected to the GPU 120, CPU 118 and FPGA 122. The central interconnect 124 is additionally connected to the input and output interface 128 and the network interface 126.

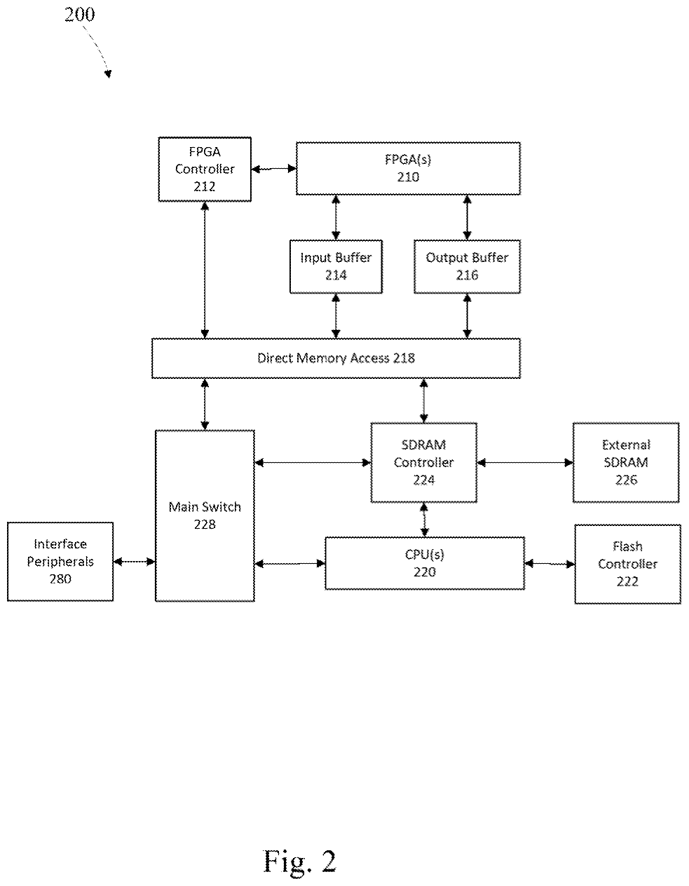

FIG. 2 depicts a second example hybrid computational system 200 that may be used to implement neural nets associated with the operation of one or more portions or steps of process 1000. In this example, the processors associated with the hybrid system comprise a field programmable gate array (FPGA) 210 and a central processing unit (CPU) 220.

The FPGA is electrically connected to an FPGA controller 212 which interfaces with a direct memory access (DMA) 218. The DMA is connected to input buffer 214 and output buffer 216, which are coupled to the FPGA to buffer data into and out of the FPGA respectively. The DMA 218 includes of two first in first out (FIFO) buffers one for the host CPU and the other for the FPGA, the DMA allows data to be written to and read from the appropriate buffer.

On the CPU side of the DMA are a main switch 228 which shuttles data and commands to the DMA. The DMA is also connected to an SDRAM controller 224 which allows data to be shuttled to and from the FPGA to the CPU 220, the SDRAM controller is also connected to external SDRAM 226 and the CPU 220. The main switch 228 is connected to the peripherals interface 230. A flash controller 222 controls persistent memory and is connected to the CPU 220.

Quantization techniques may be used in smart edge devices to improve the efficiency of deep convolution neural networks (DCNN). Quantization remaps input data from floating point numbers to a smaller set of fixed-point numbers, which may introduce an accuracy loss. Quantization may yield a more compact model and the use of vectored operations. Quantization may also be useful during inference as it may increase efficiency without an appreciable loss of accuracy.

One possible solution to achieve quantized results which match floating point results is to utilize quantization evaluation to determine which factors have the greatest effect on accuracy loss. The evaluation may compare a non-quantized neural network (NN) and a quantized neural network on a model level and a tensor level. Based on the comparison of quantized error, updates may be applied to improve the quantization. Evaluation metrics may differ for different tasks, such as classification, detection, segmentation and the like.

Several different types of quantization may be utilized. Affine quantization of floating precision tensors utilizes a fixed precision and clips values that are outside a specific range. Scale quantization is symmetric around zero and is a special case of the affine quantization. A quantized matrix multiplication converts a floating point matrix multiplication to an integer matrix multiplication. The rectified linear activation function (ReLU) is a piecewise linear function that outputs the input directly if it is positive, and outputs zero if the input is not positive, the ReLU operation may also be quantized.

Dynamic quantization utilizes integer operations as often as possible and weights are quantized into integers prior to the inference stage. Once a floating point tensor output is determined, a scale and zero point may be found and the floating point tensor may be dynamically quantized into an integer tensor.

An example workflow may include utilizing a non-quantized neural network as input, with quantization provided to quantize the neural network. The workflow may include comparing a non-quantized neural network and a quantized neural network, outputting an accuracy error between the two networks and if the error is greater than error tolerance threshold, performing a per-tensor evaluation to isolate a possible cause of the accuracy loss and reduce the accuracy loss.

Based on the error analysis, an update of the quantization may be performed and a comparison of the non-quantized neural network and quantized neural network performed to find an updated accuracy. The workflow may be terminated when the error tolerance condition is within a predetermined level.

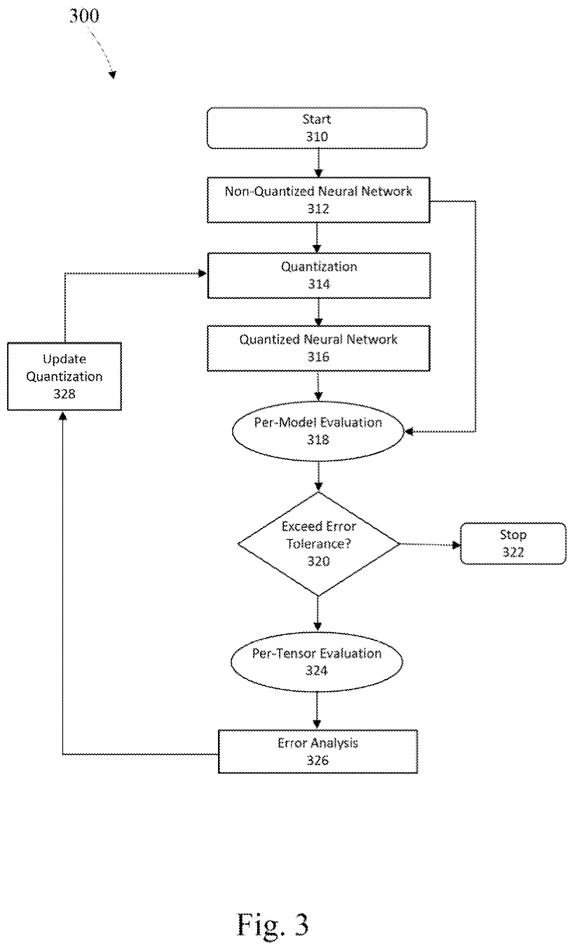

FIG. 3 depicts an example workflow that initiates with a start command 310. A non-quantized neural network output 312 may be determined, one output of the non-quantized neural network of is quantized 314 yielding 316 a quantized neural network and another output of the non-quantized neural network to be routed for use in per-model evaluation 318 that compare the non-quantized model output and the quantized model output. An error determination 320, determines whether the comparative outputs of the non-quantized neural network and the quantized neural network exceed an error tolerance, if the error is not exceeded the quantized model is kept and a stop 322 may be issued. If the error exceeds the error tolerance a per-tensor evaluation 324 is performed and a per-tensor analysis 326 yields outliers for updated quantization 328. The updated quantization may be based on the per-tensor evaluation input into the quantization model.

Quantification of a classification model may include obtaining a top-l and top-k set of accuracy errors between the non-quantized neural network and the quantized neural network. The method may apply a per-tensor evaluation metric to the non-quantized and quantized models and obtaining errors of intermediate tensors. Unstable tensors may also be determined and the model adjusted to reduce the instability. Classification models classify an image into a class label, the classification result may be normalized in a normalization layer. Therefore, the quantization process may avoid excessive error when processing the classification model. Due to hardware limitations, different quantization methods may be utilized to quantize different operators in order to retain precision.

Quantization of a detection model may include obtaining a precision multiplied by a recall curve, and tracking utilization of an average precision error between the non-quantized neural net and the quantized neural net. Unstable tensors may be analyzed for common features.

The rectified linear activation function (ReLU) is a piecewise linear function that outputs the input directly if it is positive, and outputs zero if the input is not positive. For example, errors may occur in a ReLU if utilizing symmetric power-of-2 quantization. Therefore, the ReLU operator may lose one bit precision when quantized.

Object detection detects an object class to determine the actual position of an object. When performing the detection of a position and or a regression, these layers may be more prone to quantization errors and instability than in a classification model. This may be due to the bounding box regression being mapped to the position in an original image after a decoding stage.

Convolution layers that are close to the output of a regression layer may exhibit increased quantization instability. Therefore a quantization close to an output may exhibit a quantization loss that causes a disproportionately large loss of accuracy.

Additionally, the layout of a layer may lead to different quantization parameters for that layer. The method may need to measure the quantization scale to inhibit information loss after quantization.

Semantic segmentation classifies pixels of a given image to a class and shares similarities to classification. Since each pixel may be classified without separating the instance of the same class, semantic segmentation may be dealt with as a complex version of image classification.

In one example a per-model evaluation may be performed to determine overall performance of a quantization, forgoing the per-tensor evaluation.

A first example method of quantization evaluation includes, receiving 410 a floating point data set, determining 412 a floating point neural network model output utilizing the floating point data set and quantizing 414 the floating point data set utilizing a quantization model and yielding a quantized data set. The method further includes determining 416 a quantized neural network model output utilizing the quantized data set and determining 418 whether an accuracy error between the floating point neural network model output and the quantized neural network model output exceeds an predetermined error tolerance. The method also includes determining 420 a floating point neural network tensor output utilizing the floating point data set if the predetermined error tolerance is exceeded and determining 422 a quantized neural network tensor output utilizing the quantized data set if the predetermined error tolerance is exceeded. The method also includes determining 424 a per-tensor error based on the floating point neural network tensor output and the quantized neural network tensor output and updating 426 the quantization model based on the per-tensor error.

A second example method of quantization evaluation may include quantizing 510 the floating point data set utilizing the updated quantization model yielding an updated quantized data set, determining 512 an updated quantized neural network model output utilizing the updated quantized data set and determining 514 whether an updated accuracy error between the floating point neural network model output and the updated quantized neural network model output exceeds the predetermined error tolerance. The second example method may further include determining 516 an updated quantized neural network tensor output utilizing the updated quantized data set if the predetermined error tolerance is exceeded, determining 518 an updated per-tensor error based on the floating point neural network tensor output and the updated quantized neural network tensor output and re-updating 520 the quantization model based on the updated per-tensor error.

The floating point neural network model output may include a floating point precision multiplied by recall curve, the quantized neural network model output may include a quantized precision multiplied by a recall curve and the accuracy error may include an average precision error between the floating point precision multiplied by the recall curve and the quantized precision multiplied by the recall curve. The model may also include determining which tensors are unstable based on the per-tensor error.

A third example method of quantization evaluation includes, receiving 610 a floating point data set, determining 612 a floating point neural network model output utilizing the floating point data set and quantizing 614 the floating point data set utilizing a quantization model yielding a quantized data set. The method further includes determining 616 a top-l quantized neural network model output utilizing the quantized data set and determining 618 a top-k quantized neural network model output utilizing the quantized data set. The method also includes determining 620 whether a top-l accuracy error between the floating point neural network model output and the top-l quantized neural network model output exceeds a predetermined error tolerance and determining 622 whether a top-k accuracy error between the floating point neural network model output and the top-k quantized neural network model output exceeds the predetermined error tolerance. The method further includes determining 624 a floating point neural network tensor output utilizing the floating point data set if the predetermined error tolerance is exceeded, determining 626 a top-l quantized neural network tensor output utilizing the quantized data set if the predetermined error tolerance is exceeded and determining 628 a top-k quantized neural network tensor output utilizing the quantized data set if the predetermined error tolerance is exceeded. The method also includes determining 630 a top-l per-tensor error based on the floating point neural network tensor output and the top-l quantized neural network tensor output of an intermediate tensor, determining 632 a top-k per-tensor error based on the floating point neural network tensor output and the top-k quantized neural network tensor output of the intermediate tensor and updating 634 the quantization model based on the top-l per-tensor error and the top-k per-tensor error.

A fourth example method of quantization evaluation may include, determining 710 whether a threshold of a top-l tensor instability is exceeded based on the top-l quantized neural network tensor output of the intermediate tensor, determining 712 whether a threshold of a top-k tensor instability is exceeded based on the top-k quantized neural network tensor output of the intermediate tensor and re-updating 714 the quantization model based on the top-l tensor instability and the top-K tensor instability. The method may further include quantizing 716 the floating point data set utilizing the updated quantization model yielding an updated quantized data set, determining 718 an updated top-l quantized neural network model output utilizing the updated quantized data set and determining 720 an updated top-k quantized neural network model output utilizing the updated quantized data set. The method may also include determining 722 whether an updated top-l accuracy error between the floating point neural network model output and the updated top-l quantized neural network model output exceeds the predetermined error tolerance and determining 724 whether an updated top-k accuracy error between the floating point neural network model output and the updated top-k quantized neural network model output exceeds the predetermined error tolerance. The method may include determining 726 an updated top-l quantized neural network tensor output utilizing the updated quantized data set if the predetermined error tolerance is exceeded and determining 728 an updated top-k quantized neural network tensor output utilizing the updated quantized data set if the predetermined error tolerance is exceeded. The method may also include determining 730 an updated per-tensor error based on the floating point neural network tensor output and the updated top-l quantized neural network tensor output and the updated top-k quantized neural network tensor output and re-updating 732 the quantization model based on the updated per-tensor error.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the system. Skilled artisans may implement the described functionality in varying ways for each particular application. Various components and blocks may be arranged differently (e.g., arranged in a different order, or partitioned in a different way) without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects may be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code may be construed as a processor programmed to execute code or operable to execute code.

A phrase such as an “aspect” does not imply that such aspect is essential to the subject technology or that such aspect applies to configurations of the subject technology. A disclosure relating to an aspect may apply to configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to configurations of the subject technology. A disclosure relating to an embodiment may apply to embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to configurations of the subject technology. A disclosure relating to a configuration may apply to configurations, or one or more configurations. A configuration may provide one or more examples. A phrase such as a “configuration” may refer to one or more configurations and vice versa.

The word “example” is used herein to mean “serving as an example or illustration.” Any aspect or design described herein as “example” is not necessarily to be construed as preferred or advantageous over other aspects or designs.

Structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

References to “one embodiment,” “an embodiment,” “some embodiments,” “various embodiments”, or the like indicate that a particular element or characteristic is included in at least one embodiment of the invention. Although the phrases may appear in various places, the phrases do not necessarily refer to the same embodiment. In conjunction with the present disclosure, those skilled in the art may be able to design and incorporate any one of the variety of mechanisms suitable for accomplishing the above described functionalities.

It is to be understood that the disclosure teaches just one example of the illustrative embodiment and that many variations of the invention may easily be devised by those skilled in the art after reading this disclosure and that the scope of then present invention is to be determined by the following claims.

What is claimed is:

1. A method of quantization evaluation, comprising:
receiving a floating point data set;
determining a floating point neural network model output utilizing the floating point data set;
quantizing the floating point data set utilizing a quantization model yielding a quantized data set;
determining a quantized neural network model output utilizing the quantized data set;
determining whether an accuracy error between the floating point neural network model output and the quantized neural network model output exceeds an predetermined error tolerance;
determining a floating point neural network tensor output utilizing the floating point data set if the predetermined error tolerance is exceeded;
determining a quantized neural network tensor output utilizing the quantized data set if the predetermined error tolerance is exceeded;
determining a per-tensor error based on the floating point neural network tensor output and the quantized neural network tensor output; and
updating the quantization model based on the per-tensor error.

2. The method of quantization evaluation of claim 1, further comprising:
quantizing the floating point data set utilizing the updated quantization model yielding an updated quantized data set;
determining an updated quantized neural network model output utilizing the updated quantized data set; and
determining whether an updated accuracy error between the floating point neural network model output and the updated quantized neural network model output exceeds the predetermined error tolerance.

3. The method of quantization evaluation of claim 2, further comprising:
determining an updated quantized neural network tensor output utilizing the updated quantized data set if the predetermined error tolerance is exceeded;
determining an updated per-tensor error based on the floating point neural network tensor output and the updated quantized neural network tensor output; and
re-updating the quantization model based on the updated per-tensor error.

4. The method of quantization evaluation of claim 1, wherein
the floating point neural network model output includes a floating point precision multiplied by recall curve; and
the quantized neural network model output includes a quantized precision multiplied by a recall curve.

5. The method of quantization evaluation of claim 4, wherein the accuracy error includes an average precision error between the floating point precision multiplied by the recall curve and the quantized precision multiplied by the recall curve.

6. The method of quantization evaluation of claim 5, further including determining unstable tensors based on the per-tensor error.

7. A method of quantization evaluation, comprising:
receiving a floating point data set;
determining a floating point neural network model output utilizing the floating point data set:
quantizing the floating point data set utilizing a quantization model yielding a quantized data set;
determining a top-l quantized neural network model output utilizing the quantized data set;
determining a top-k quantized neural network model output utilizing the quantized data set;
determining whether a top-l accuracy error between the floating point neural network model output and the top-l quantized neural network model output exceeds a predetermined error tolerance;
determining whether a top-k accuracy error between the floating point neural network model output and the top-k quantized neural network model output exceeds the predetermined error tolerance;
determining a floating point neural network tensor output utilizing the floating point data set if the predetermined error tolerance is exceeded;
determining a top-l quantized neural network tensor output utilizing the quantized data set if the predetermined error tolerance is exceeded;
determining a top-k quantized neural network tensor output utilizing the quantized data set if the predetermined error tolerance is exceeded;
determining a top-l per-tensor error based on the floating point neural network tensor output and the top-l quantized neural network tensor output of an intermediate tensor;
determining a top-k per-tensor error based on the floating point neural network tensor output and the top-k quantized neural network tensor output of the intermediate tensor; and
updating the quantization model based on the top-l per-tensor error and the top-k per-tensor error.

8. The method of quantization evaluation of claim 7 further comprising;
determining whether a threshold of a top-l tensor instability is exceeded based on the top-l quantized neural network tensor output of the intermediate tensor;
determining whether a threshold of a top-k tensor instability is exceeded based on the top-k quantized neural network tensor output of the intermediate tensor; and
re-updating the quantization model based on the top-l tensor instability and the top-K tensor instability.

9. The method of quantization evaluation of claim 8, further comprising:
quantizing the floating point data set utilizing the updated quantization model yielding an updated quantized data set;
determining an updated top-l quantized neural network model output utilizing the updated quantized data set;
determining an updated top-k quantized neural network model output utilizing the updated quantized data set;
determining whether an updated top-l accuracy error between the floating point neural network model output and the updated top-l quantized neural network model output exceeds the predetermined error tolerance; and
determining whether an updated top-k accuracy error between the floating point neural network model output and the updated top-k quantized neural network model output exceeds the predetermined error tolerance.

10. The method of quantization evaluation of claim 9, further comprising:
determining an updated top-l quantized neural network tensor output utilizing the updated quantized data set if the predetermined error tolerance is exceeded:
determining an updated top-k quantized neural network tensor output utilizing the updated quantized data set if the predetermined error tolerance is exceeded;
determining an updated per-tensor error based on the floating point neural network tensor output and the updated top-l quantized neural network tensor output and the updated top-k quantized neural network tensor output; and
re-updating the quantization model based on the updated per-tensor error.
